(19) United States
(12) Patent Application Publication
(10) Pub. No.: US 2011/0299426 A1
(43) Pub. Date: Dec. 8, 2011

(54) Starting a Wireless Communications Network using wireless signal

(76) Inventor: Praveen Kumar, Bangalore (IN)

(21) Appl. No.: 13/201,923

(22) PCT Filed: Feb. 11, 2010
(86) PCT No.: PCT/IN2010/000077

§ 371 Date: Aug. 17, 2011

(30) Foreign Application Priority Data
Feb. 23, 2009 (IN) 162/CHE/2009

(51) Int. Cl. H04W 52/02; H04W 84/10

(52) U.S. Cl. 370/256; 370/311; 370/338

(57) ABSTRACT

Embodiments herein provide a method and system for switching a wireless device from low power consumption dormant mode to active mode in a wireless communication network (WCN) using a switch command frame (SCF). The SCF is transmitted repeatedly for continuous configurable period of time, long enough to provide multiple opportunities to the dormant nodes to listen to the same and change its mode appropriately. This invention improves the power efficiency of the node when it is not associated with any network.

### FIELD OF THE INVENTION

This invention relates to the field of activating a wireless device from low power consumption mode to active mode using wireless signal.

### BACKGROUND OF THE INVENTION

The power efficiency of wireless communication networks are major concern for the scientists all over the world. One of the main reasons which make the wireless communications network different than the conventional network system is its limited power. As an example, IEEE 802.15.4 based wireless personal area network (WPAN), the other desired characteristics are that it should be self-organizing, self-healing and adaptive to the changes in their environment. As part of self-organization, the device on power-on scans the frequency channels based on the preference list provided to get associated to the network in its vicinity. After scanning for a configurable period, the device generates a report of received signals and its network information. Based on its preference list, it then initiates the association process with the preferred network element from which it had previously heard during the frequency channel scan procedure. In case if the device did not find the preferred network on the scanned frequency channel, the device changes the frequency channel and again performs the same scan procedure as discussed above. The device keeps scanning all the frequency channels configured in its channel list continuously till it finds the desired network. In a normal configuration, the network elements transmit the beacon in small (e.g. 572 micro second) bursts; the device which wants to join the network listens to the beacon transmitted by the network element, uses it to synchronize with the network element and then initiates the association procedure. Since the network elements transmit beacons in small bursts, the receiver node should be in active listening state continuously for a duration greater than the time period between two beacons (superframe duration), which in practice is very long compared to beacon frame and can grow up to couple of minutes, before it could conclude that the channel being scanned is in use or not. The continuous scan of channels for such long periods consumes lots of energy and reduces the life of the device significantly. Let us consider a scenario where there is no coordinator transmitting the beacon, either due to its failure or during initial setup, for half an hour. The receiver nodes continue to scan all channels for the beacon in this period and hence are always on, till they are associated or re-associated. As an example, if these are Texas Instrument device transceivers TI (MRF24J40) with microcontrollers (MSP430×20×1), and scan for a nearby network for the duration of half an hour, it will lose its 15.2% of life if powered by two alkaline batteries (60 mAh). This is a significant loss and the proposed invention helps in reducing such loss drastically.

### SUMMARY OF INVENTION

The proposed invention in this document introduces a new state for devices termed as dormant state. In the dormant state, the wireless device is powered-on but it is not connected to any network; it keeps listening periodically for a newly introduced bit sequence termed as start association command (SAC). On reception of the start association command (SAC) the device changes its mode from dormant to active mode and starts scanning the channel for association. The device can reach this dormant state in multiple ways, for example, as soon as it is powered-on, or if it has lost connection with the existing network, or by explicit request from the network to change its state from connected to dormant state at the time of network maintenance. In dormant state the device listens periodically for a pre-configured period of time in which on receiving any relevant signal it continues the reception till gets synchronized with the transmitter and decodes the command. There can be different types of command depending upon the situation; as an example the start association command (SAC) shall be used to switch the device from dormant state to active state and start the association procedure. On changing to active state, if the device is not part of network then it shall start searching for neighboring networks and the network elements which want other unassociated devices to associate with it shall start transmitting beacon.

In this document SAC is taken as an example to explain the innovation. It shall not be taken as its limitation; different bit sequence can be transmitted to indicate different types of command based on the situation.

As per existing algorithms the coordinator nodes transmit the synchronization information in bursts and the node which wants to get synchronized and associate with the network shall listen to the frequency channels in continuous manner. In this invention we have reversed the role of coordinator node and the device which want to get synchronized and associate with the coordinator node. As per this invention, the coordinator node will be transmitting the start association command with the synchronization information in continuous manner for the duration sufficient enough to provide at least one opportunity for the device in dormant state to listen and take appropriate action. Start association command together with synchronization information is called as switch command frame (SCF) in this document. The continuous transmission of SCF can consume considerable power. Depending upon the network environment and convenience the sequence of SCF can also be transmitted using external equipment if proper information is fed in the equipment.

### BRIEF DESCRIPTION OF DRAWINGS

The preferred embodiments of the present invention will hereinafter be described in conjunction with the appended drawings provided to illustrate and not to limit the invention, wherein like designations denote like elements, and in which:

FIG. 1 illustrates an exemplary wireless communications network;

FIG. 2 illustrates an exemplary sequence of switch command frames (SCF);

FIG. 3 illustrates an exemplary start association command (SAC) field format;

FIG. 4 illustrates an exemplary time domain of a dormant and wake-up frame transmitting device, in accordance with various embodiments of the invention.

### DETAILED DESCRIPTION OF INVENTION WITH RESPECT TO DRAWINGS

In the following description, the present invention has been illustrated in the context of a Wireless Personal Area Network (WPAN) and particularly IEEE 802.15.4 based wireless sensor network. However, it will be apparent to those ordinarily skilled in the art the applicability of the invention to many other wireless systems.

Various embodiments of the present invention provide a method and system for association of a device in a wireless communication network. In a conventional WPAN governed by the standard IEEE 802.15.4, the process of association starts with channel scan process. The device intends to join any network first scans the channel based on the preference list and reports it to the higher layer in the stack. Based on the report the higher layer requests the lower medium access control (MAC) and physical layer (PHY) to transmit the association request to one of the networks of its preference. In case if the device doesn't find any suitable network it keeps scanning the channel for some pre-configured time. At the time of channel scanning, the device keeps listening to the channel continuously for preconfigured period of time which is normally higher than the average periodicity of beacons of normal wireless sensor network. Continuous scan for such a large period and in worst case for different channels is a power expensive task. In this invention we have developed an algorithm which allows the unassociated nodes to be in low power consumption mode. It reduces the battery consumption of the devices when the network is under maintenance or when there is uncertainty that when the network formation will start.

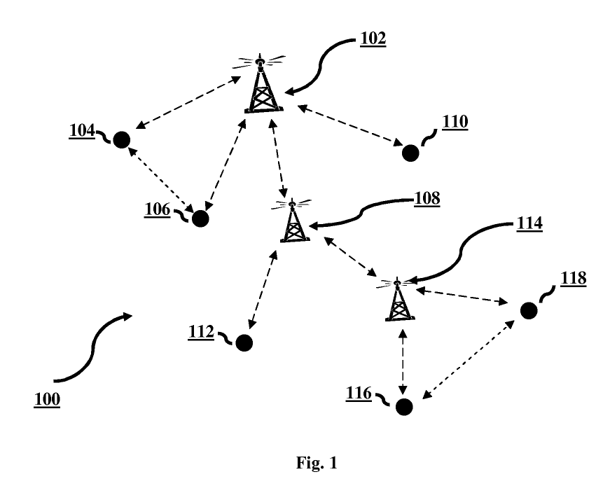

FIG. 1 illustrates an exemplary wireless network 100. 102 is illustrated as wireless personal area network controller (PC); 104, 106, 108 and 110 are associated with PC where 104, 106 and 110 are reduced function device leaf nodes LNs and 108 is a full function device router node (RN). As illustrated, RN 108 allows further level of association with it. 112 and 114 are associated with RN 108, where 112 is a LN and 114 is a RN. RN 114 further allowing network to grow by associating 116 and 118. Node which associates other nodes is called as parent node for the associated nodes, whereas the associated nodes are called child nodes of that parent node. In this manner network can grow multiple hops and covers the required area. The bi-directional arrows denote that the nodes are in their radio sphere of influence and can communicate with it.

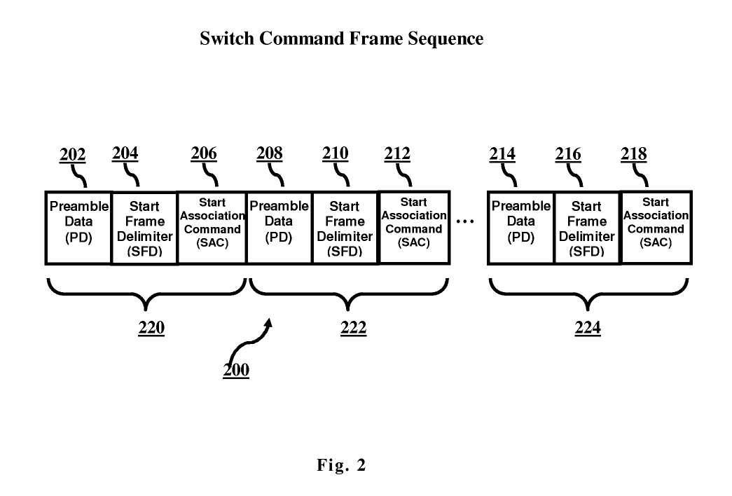

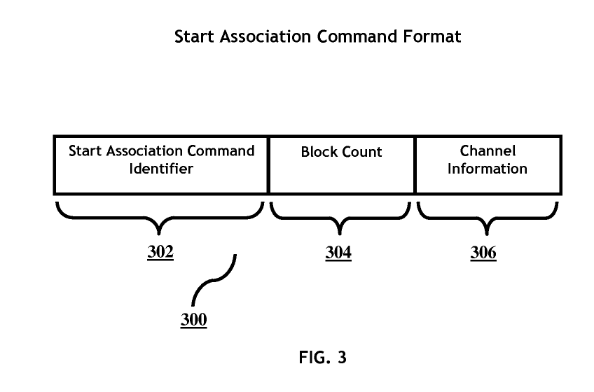

FIG. 2 illustrates the sequence of switch command frames 200 (SCF). A switch command frame constitutes of preamble data (PD), start frame delimiter (SFD) and start association command (SAC). Sequence of SCF 220, 222, 224 will be transmitted for unassociated devices to get synchronized using PD and SFD, decode the SAC and then switch from dormant mode to active mode and start association procedure. As discussed earlier, SCF sequence can be transmitted by a full function device network element such as PC, RN or external equipment; this is also called as switch command triggering device (SCTD) in this document. The preamble data 202, 208, 214 will be used for frequency synchronization. Time synchronization will be achieved by decoding the SFD 204, 210, 216. The SAC 206, 212, 218 is command to start the association procedure, which is further comprised of start scan command identifier, block count and channel information as illustrated in FIG. 3.

The unassociated devices which are in dormant state, on reception of SCF shall start the association procedure. The periodicity of listening of the dormant devices shall be configured based on the type of equipment used for transmitting the SCF sequence, as discussed earlier it can be either internal network element or an external equipment. If the SCF sequence transmitter is external equipment, then it shall be easy to maintain such equipment and hence it shall be configured to transmit long SCF sequence and the receivers which are in dormant state shall attempt to listen with less periodicity. But if the triggering device SCTD is part of the network then its energy should be used in most efficient way and in that case the coordinator node shall transmit the SCF sequence for optimum duration and hence the dormant nodes shall try to listen to SCF 220 with higher periodicity than in previous situation. As mentioned earlier, the SCF sequence shall be of at least one time period of dormant node reception attempt.

Depending on the factors comprising of current characteristics of microcontroller and transceiver chip, the expected time by which the network will start network formation and the device type of SCF sequence transmitter i.e. an external equipment or internal network element, the optimum length of switch command frame sequence shall be calculated and accordingly the reception attempt periodicity of the dormant node shall be configured.

FIG. 3 illustrates exemplary format of start association command 300 (SAC). As illustrated the SAC comprises of start association command identifier 302 (SACId), block count 304 (BC) and channel information 306 (CI). SACId is to indicate that the dormant nodes shall start its association procedure. The block count contains the number of SCF that will be transmitted before the beacon frame; the dormant device can go to low power consumption mode if it finds that the time gap for beacon frame is sufficient and it can save power by changing its mode to low power consumption mode and again come back to active when the beacon frame is expected. The CI field contains the frequency channel information on which the dormant device shall attempt to listen for the beacon frame.

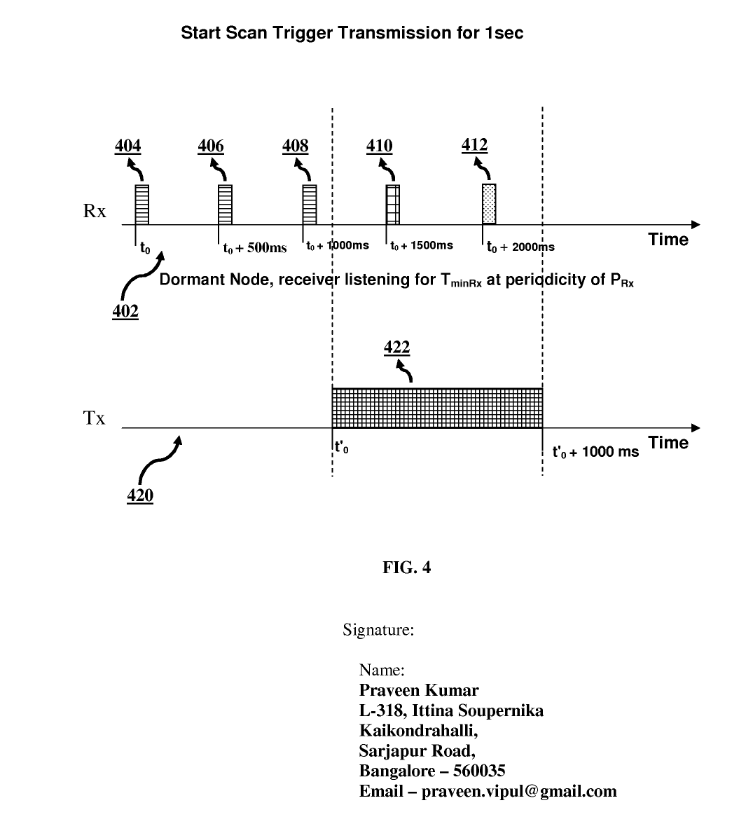

FIG. 4 illustrates exemplary time domain of dormant mode device 402, and SCF sequence transmitter 420. The dormant device becomes active periodically in receive mode and tries to listen to the switch command frame at 404, 406, 408 and 410. As illustrated in FIG. 4, the attempt 410 lies in the SCF sequence period; the node will be able to receive the SAC and take action appropriately. The SCF triggering device transmits the SCF at 422, as an example the SCF sequence duration is of two time period of dormant device reception attempt, i.e. the dormant device will get two opportunities to listen to the SCF and initiate the association procedure. As illustrated in FIG. 4, if the device would not have been able to decode the SCF at 410, it would have got one more opportunity to listen to SCF at 412 and take the necessary action.

This invention has also introduced a deep sleep mode, in which the unassociated device can go in sleep mode till configured period of time and after the elapse of the said configured time the device will change its mode to dormant mode. This invention, will further improve the power efficiency where the network has prior knowledge of when it will start or restart the network formation.

What is claimed is:

1. A method of communicating to a dormant wireless device having networking capabilities but not yet associated with a wireless communication network to trigger the network association procedure to associate it to said wireless communication network, said method comprising the steps of:
creating switch command frame by the switch command triggering device of the network, when starting the network formation;
said switch command triggering device transmitting said switch command frame in repeated manner for configurable duration T_{SCF};
said unassociated dormant device periodically listening at configurable periodicity. P_{Rx} for a configurable duration T_{minRx} sufficient to evaluate whether relevant information i.e. switch command frame or beacon frame is getting transmitted or not; and
on detecting said switch command frame or beacon frame, the unassociated dormant device starting the association procedure
whereby, said wireless device gets associated with said network and becomes part of the network.

2. The length of said switch command frame sequence as claimed in claim 1 is configured based on the factors comprising,
current characteristics of microcontroller and transceiver chip i.e. the transition time to switch between different operating states and the electricity consumption in respective states by said chips;
estimated time range in which the network formation will start;
number of opportunities said dormant device shall get to listen to said switch command frame sequence;
said configurable periodicity (P_{Rx}) of dormant device to listen to said switch command frame;
said configurable duration (T_{minRx}) for which said dormant device attempts to listen to said switch command frame, and
type of said switch command triggering device.

3. The length of said switch command frame sequence as claimed in claim 1 is designed to provide said number of opportunities the dormant device shall get to listen to said switch command frame sequence.

4. The length of said switch command frame sequence as claimed in claim 1 is directly proportional to said transition time to switch between different operating states, current consumption in active reception state of transceiver, said estimated time range in which the network formation will start, number of opportunities said dormant device shall get to listen to said switch command frame sequence and said configurable periodicity (P_{Rx}) of dormant device to listen to said switch command frame.

5. The length of said switch command frame sequence as claimed in claim is inversely proportional to current consumption in active transmission state of transceiver and said configurable duration (T_{minRx}) for which said dormant device attempts to listen to said switch command frame.

6. The switch command triggering device as claimed in claim 1, is a device which triggers the association procedure, it can be either network associated full function device such as personal area network controller (PC) or router node, or external equipment used for network maintenance activities.

7. The unassociated dormant device as claimed in claim 1, on failing to detect said switch command frame or beacon frame from the network, changes its transceiver and microcontroller to low power consumption mode till next reception slot i.e. for P_{Rx}-T_{minRx} duration.

8. The switch command frame as claimed in claim 1 comprising preamble data (PD), start frame delimiter (SFD) and start association command (SAC)
wherein said start association command field further comprising start association command identifier (SACId), block count (BC) and the frequency channel information (CI), and
wherein said start association command identifier contains the information to indicate that the current frame contains start association command,
said block count contains the information about the time delay after which the beacon frame will be transmitted and
said frequency channel information contains the frequency channel information on which the beacon will be transmitted.

9. The dormant device as claimed in claim 1, represents the state of the device with networking capability but not connected with any network wherein said dormant device, periodically activates itself in reception mode at configurable period P_{Rx} to listen to any relevant signal such as switch command frame or beacon frame from the low, power consumption mode, whereby power saving is achieved.

10. The method of communicating to an dormant wireless device as claimed in claim 1 comprising a method to reduce power consumption by the said dormant wireless device comprising, introducing a low power consumption mode termed as deep sleep mode, wherein said dormant wireless device shall be in low power consumption mode for configurable period of time i.e. no periodic reception shall happen in this period and after the elapse of said configurable period of time it shall change its mode to said dormant mode.

11. A system for networking a wireless communication device having networking capabilities with a wireless communication network as claimed in claim 1 comprising, a full function device personal area network controller (PC) and a reduced function device leaf node (LN),
means for creating switch command frame when starting the network formation;
means for transmitting said switch command frame in repeated manner for configurable duration T_{SCF};
means for periodically listening at configurable periodicity P_{Rx} for a configurable duration T_{minRx} sufficient to evaluate whether relevant information i.e. switch command frame or beacon frame is getting transmitted or not; and
means for starting the association procedure on detecting said switch command frame or beacon frame;
whereby, said wireless device gets associated with said network and becomes part of the network.

12. The system as claimed in claim 11 comprising, a full function device personal area network controller, a full function device router node and a reduced function device leaf node.

13. The system as claimed in claim 11 comprising, a full function device personal area network controller, a full function device router node, a reduced function device leaf node and a portable network maintenance device.

14. The system as claimed in claim 11 comprising, a full function device personal area network controller (PC) and a reduced function device leaf node and a portable network maintenance device.

15. The full function device mentioned in claim 11 is a wireless networking device capable of networking with reduced function device or other full function device and it is capable to operate in three modes serving as personal area network controller (PC), a router node (RN) or as a leaf node (LN).

16. The reduced function device mentioned in claim 11 is a wireless networking device capable of networking with only full function device and it can serve as leaf node (LN) in any network.

17. The full function device as claimed in claim 11 is
adapted to create said switch command frame when starting the network formation;
adapted to transmit said switch command frame in repeated manner for configurable duration T_{SCF}.

18. The reduced function as claimed in claim 11 is
adapted to listen periodically at configurable periodicity P_{Rx} for a configurable duration T_{minRx} sufficient to evaluate whether relevant information i.e. switch command frame or beacon frame is getting transmitted or not;
adapted to start the association procedure on detecting said switch command frame or beacon frame;
adapted to switch to low power consumption mode when idle;

19. The portable network maintenance device as claimed in claim 13 is
adapted to get configured by any network element or by external equipment;
adapted to create said switch command frame when configured to start the network formation;
adapted to transmit said switch command frame in repeated manner for configurable duration T_{SCF} at configurable transmission power;
